(19) United States
(12) Patent Application Publication
(10) Pub. No.: US 2015/0309553 A1
(43) Pub. Date: Oct. 29, 2015

(54) SERVER AND METHOD FOR ADJUSTMENT OF FREQUENCY OF MONITORING COMPONENTS OF SERVER

(71) Applicant: HON HAI PRECISION INDUSTRY CO., LTD., New Taipei (TW)

(72) Inventor: YU-CHEN HUANG, New Taipei (TW)

(21) Appl. No.: 14/696,621

(22) Filed: Apr. 27, 2015

(30) Foreign Application Priority Data
Apr. 28, 2014 (TW) 103115235

(51) Int. Cl. G06F 1/32; G06F 11/30

(52) U.S. Cl. CPC G06F 1/324; G06F 1/3206; G06F 11/3062

(57) ABSTRACT

A monitoring frequency adjustment method monitors a power state of each of the plurality of components at preset intervals, determines a monitoring frequency of each of the plurality of components associated with the determined power state of a corresponding one of the plurality of components, and adjusts the preset intervals for monitoring each of the plurality of components to the determined monitoring frequency of the corresponding one of the plurality of components. A related server and a related non-transitory storage medium are provided.

### CROSS-REFERENCE TO RELATED APPLICATIONS

This application claims priority to Taiwanese Patent Application No. 103115235 filed on Apr. 28, 2014, the contents of which are incorporated by reference herein.

### FIELD

The subject matter herein generally relates to monitoring server and component performances.

### BACKGROUND

Baseboard management controllers (BMCs) are installed in servers to monitor operations of components of the servers at fixed intervals (e.g. 5 seconds) whether heat being emitted by the components is below or greater than a preset value (e.g. 300 watts).

### BRIEF DESCRIPTION OF THE DRAWINGS

Implementations of the present technology will now be described, by way of example only, with reference to the attached figures.

FIG. 1 is a block diagram showing an embodiment of a server.

FIG. 2 is a block diagram showing an embodiment of a monitoring frequency adjustment system in relation to the server of FIG. 1 and its components.

FIG. 3 is a flowchart showing an embodiment of a monitoring frequency adjustment method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The term “comprising” means “including, but not necessarily limited to”; it specifically indicates open-ended inclusion or membership in a so-described combination, group, series and the like.

Embodiments of the present disclosure will be described with reference to the accompanying drawings.

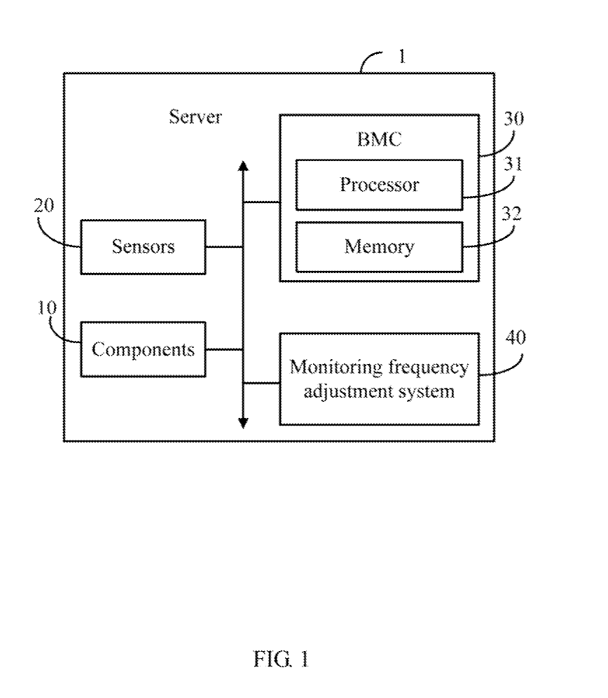

FIG. 1 illustrates an embodiment of a server 1. The server 1 can include a number of components 10, a number of sensors 20, and a baseboard management controller (BMC) 30. In the embodiment, the components 10 can be a Central Processing Unit (CPU), a Memory, a Platform Controller Hub (PCH), and a Power Supply Unit (PSU), for example. In the embodiment, each component 10 can be coupled to the BMC 30. In the embodiment, each sensor 20 can sense an actual power consumption of a corresponding component 10. In the embodiment, the BMC 30 is a microcontroller installed on a motherboard of the server 1. The BMC 30 can contain a processor 31 and a memory 32. In the embodiment, the memory 32 can be coupled to the processor 31. In the embodiment, the BMC 30 can monitor the operation of the components 10. In detail, the BMC 30 can be applied in an intelligent platform management interface (IPMI) architecture. The BMC 30 can connect to the sensors 20 to obtain the actual power consumption of each component 10 via a system interface of the IPMI architecture, for example, an Intelligent Platform Management Bus/Bridge (IPMB) of the IPMI architecture, or an enhanced implementation of Inter-Integrated Circuit (I2C) of the IPMI architecture. In the embodiment, the server 1 can automatically adjust the monitoring frequency of each component 10 according to the actual power consumption sensed by a corresponding sensor 20.

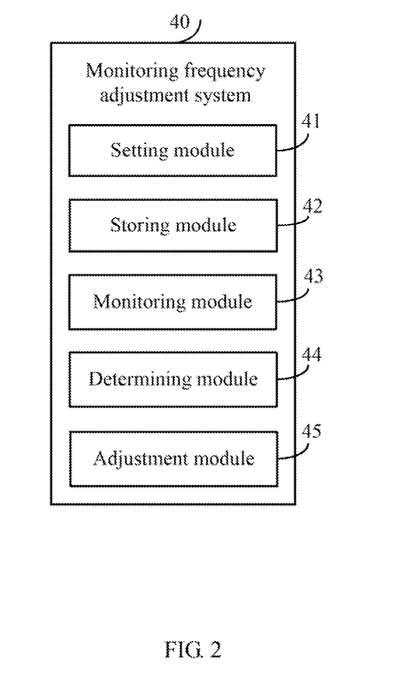

In the embodiment, the server 1 can further include a monitoring frequency adjustment system 40 illustrated in FIG. 2. The monitoring frequency adjustment system 40 can include a setting module 41, a storing module 42, a monitoring module 43, a determining module 44, and an adjustment module 45. One or more programs of the function modules of the monitoring frequency adjustment system 40 can be stored in the memory 32 of the BMC 30 and be executed by the processor 31 of the BMC 30. In the embodiment, the BMC 30 can further store a rated power consumption of each component 10. In the embodiment, the rated power consumption of each component 10 can be a rated power of each component 10.

The setting module 41 can be configured to set a number of power states for each component 10 and set a monitoring frequency for each power state of each component 10.

In the embodiment, the power states of each component 10 can be same. The power states of each component 10 can include a maximum power state, a high power state, and a low power state. In the embodiment, each power state of each component 10 can be represented via a corresponding power percentage range. In the embodiment, the power percentage range can be a value equal to a rated power consumption divided by an actual power consumption. In the embodiment, the power percentage range of each component 10 at a same power state can be same. In the embodiment, the maximum power state can be the component 10 running in the server 1 with a first power percentage range, namely 100% power. The high power state can be the component 10 running in the server 1 with a second power percentage range, namely a power percentage greater than a preset power percentage (e.g. 80% power) but less than the 100% power. The low power state can be the component 10 running in the server 1 with a third power percentage range, namely a power percentage less than the preset power percentage (e.g. 80% power). In the embodiment, the power states and the preset power percentage ranges can be edited by the user. In other embodiments, the power states of each component 10 can be different and the power percentage range of each component 10 at a same power state can be different.

In the embodiment, the heat emitted by a component 10 changes with different power states of the component 10. The heat emitted by a component 10 at the maximum power state can be greater than the heat emitted by that component 10 at the high power state, and the heat emitted by that component 10 at the high power state can be greater than the heat emitted by that component 10 at the low power state. Thus, the monitoring frequency of each component 10 decreases as the power state of the corresponding component 10 changes (reduces from) from the maximum power state to the high power state, and from the high power state to the low power state, or directly from the maximum power state to the low power state. In the embodiment, the monitoring frequencies of different components 10 at the same power state can be same. For example, the monitoring frequencies of all components 10 at the maximum power state can be 1 second. In other embodiments, the monitoring frequencies of different components 10 at the same power state can be different. For example, the monitoring frequency of the CPU at the maximum power state can be 1 second, the monitoring frequency of the Memory at the maximum power state can be 2 seconds, the monitoring frequency of the PCH at the maximum power state can be 2 seconds, and the monitoring frequency of the PSU at the maximum power state can be 3 seconds.

In the embodiment, the storing module 42 can be configured to store the power states of each component 10 and the monitoring frequencies associated with each component 10 at different power states to the memory 32 of the BMC 30. In the embodiment, the storing module 42 can be further configured to store the power percentage ranges of the components 10 associated with the power states of the components 10 to the memory 32 of the BMC 30.

In the embodiment, the monitoring module 43 can be configured to monitor the power state of each component 10 at preset intervals. In the embodiment, the monitoring module 43 can determine a power percentage of each component 10 at preset intervals to monitor the power state of each component 10 at preset intervals. In detail, the monitoring module 43 can obtain the actual power consumption of each component 10 from the corresponding sensor 20 via the system interface of the IPMI architecture, i.e., the IPMB or the I2C. The monitoring module 43 can determine the power percentage of each component 10 according to the obtained power consumption of each component 10 and the stored rated power consumption of each component 10, determine which power percentage range of each component 10 that the determined power percentage of a corresponding component 10 falls into, and further determine the power state of each component 10 associated with the determined power percentage range of the corresponding component 10.

In the embodiment, the determining module 44 can be configured to determine the monitoring frequency of each component 10 associated with the determined power state of the corresponding component 10. For example, when the CPU, the Memory, the PCH, and the PSU are all at the maximum power state, the determining module 44 determines that the monitoring frequencies of CPU, Memory, PCH, and PSU are all at 5 seconds.

In the embodiment, the adjustment module 45 can be configured to adjust the preset intervals at which the monitoring module 43 monitors each component 10 to the determined monitoring frequency of the corresponding component 10. The BMC 30 can accordingly at the corresponding monitoring frequency to perform fault monitoring, security monitoring, configuration monitoring, and the like. The monitoring module 43 can accordingly monitor the power state of each component 10 at the corresponding monitoring frequency.

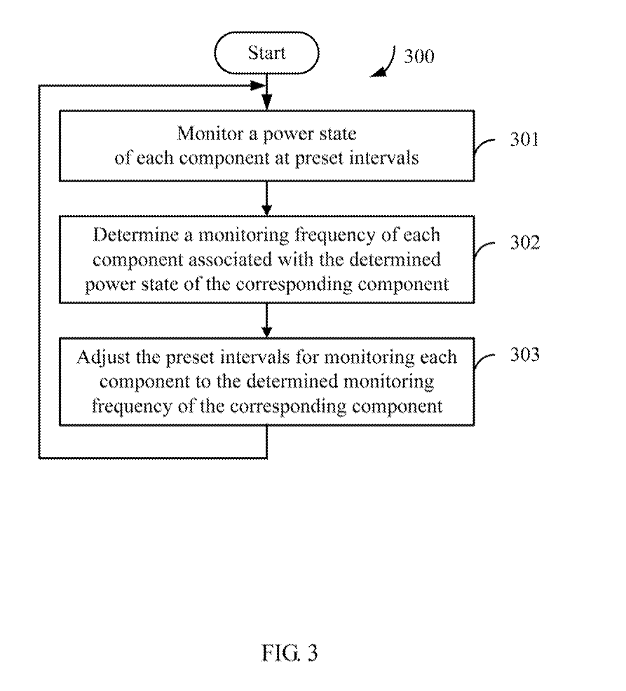

FIG. 3 illustrates an embodiment of a monitoring frequency adjustment method 300. In the embodiment, the method 300 is provided by way of example, as there are a variety of ways to carry out the method 300. The method 300 described below can be carried out using the configurations illustrated in FIGS. 1 and 2, for example, and various elements of these figures are referenced in the explanation of the method 300. Each block shown in FIGS. 1 and 2 represent one or more processes, methods, or subroutines carried out in the method. Additionally, the illustrated order of blocks is by example only and the order of the blocks can change. The method 300 can begin at block 301.

At block 301, a monitoring module monitors a power state of each component at preset intervals. In the embodiment, the monitoring module determines a power percentage of each component at preset intervals to monitor the power state of each component at preset intervals. In detail, the monitoring module obtains an actual power consumption of each component from a corresponding sensor via a system interface of the IPMI architecture, i.e. an Intelligent Platform Management Bus/Bridge (IPMB) or an enhanced implementation of Inter-Integrated Circuit (I2C). The monitoring module determines a power percentage of each component according to the obtained power consumption of each component and a stored rated power of each component, determines which power percentage range of each component that the determined power percentage of a corresponding component falls into, and further determines the power state of each component associated with the determined power percentage range of the corresponding component.

At block 302, a determining module determines a monitoring frequency of each component associated with the determined power state of the corresponding component.

At block 303, an adjustment module adjusts the preset intervals at which the monitoring module monitors each component to the determined monitoring frequency of the corresponding component.

In the embodiment, a setting module sets a number of power states for each component and sets a monitoring frequency for each power state of each component. In the embodiment, each power state of each component is represented via a corresponding power percentage range. The power percentage is a value which equals to a rated power consumption divided by an actual power consumption. A storing module stores the power states of each component and the monitoring frequencies associated with each component at different power states to the memory of the BMC. In the embodiment, the storing module further stores the power percentage ranges of the components associated with the power states of the components to the memory of the BMC.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A server comprising:
a baseboard management controller (BMC) comprising a processor and a non-transitory storage medium coupled to the processor;
a plurality of components of the server, each of the plurality of components being coupled to the BMC; and
the non-transitory storage medium storing a relationship between a plurality of components, a plurality of power states, and a plurality of monitoring frequencies; each of the plurality of components associating with some of the plurality of power states, each of the power states associating with one of the monitoring frequencies;
the non-transitory storage medium configured to store instructions for the processor to:
monitor a power state of each of the plurality of components at preset intervals;
determine a monitoring frequency of each of the plurality of components associated with the determined power state of a corresponding one of the plurality of components; and
adjust the preset intervals for monitoring each of the plurality of components to the determined monitoring frequency of the corresponding one of the plurality of components.

2. The server as described in claim 1, wherein the non-transitory storage medium stores instructions for the processor to:
determine a power percentage of each of the plurality of components at preset intervals to monitor the power state of each of the plurality of components at preset intervals.

3. The server as described in claim 2, further comprising a plurality of sensors, each of the plurality of sensors sensing an actual power consumption of a corresponding one of the plurality of components, each of the plurality of sensors being coupled to the BMC; wherein the non-transitory storage medium stores instructions for the processor to:
obtain the actual power consumption of each of the plurality of components from a corresponding one of the plurality of sensors via a system interface of an IPMI architecture;
determine a power percentage of each of the plurality of components according to the obtained actual power consumption of each of the plurality of components and a stored rated power consumption of each of the plurality of components;
determine which power percent range of each of the plurality of components that the determined power percent of a corresponding one of the plurality of component falls into; and
determine the power state of each of the plurality of components associated with the determined power percentage range of the corresponding one of the plurality of components.

4. The server as described in claim 1, wherein the non-transitory storage medium stores instructions for the processor to:
set a plurality of power states for each of the plurality of components and set a monitoring frequency for each of the plurality of power states of each of the plurality of components; and
store the power states of each of the plurality of components and the monitoring frequencies associated with each of the plurality of components at different power states.

5. The server as described in claim 4, wherein each of the plurality of power states of each of the plurality of components is represented via a corresponding one of the plurality of power percentage ranges.

6. The server as described in claim 5, wherein the non-transitory storage medium stores instructions for the processor to:
store the power percentage ranges of the components associated with the power states of the components to the non-transitory storage medium of the BMC.

7. A monitoring frequency adjustment method comprising:
monitoring a power state of each of the plurality of components at preset intervals;
determining a monitoring frequency of each of the plurality of components associated with the determined power state of a corresponding one of the plurality of components; and
adjusting the preset intervals for monitoring each of the plurality of components to the determined monitoring frequency of the corresponding one of the plurality of components.

8. The monitoring frequency adjustment method as described in claim 7, wherein the method further comprises:
determining a power percentage of each of the plurality of components at preset intervals to monitor the power state of each of the plurality of components at preset intervals.

9. The monitoring frequency adjustment method as described in claim 8, wherein the method further comprises:
obtaining an actual power consumption of each of the plurality of components from a corresponding one of the plurality of sensor via a system interface of an IPMI architecture;
determining a power percent of each of the plurality of components according to the obtained actual power consumption of each of the plurality of components and a stored rated power consumption of each of the plurality of components;
determining which power percent range of each of the plurality of components that the determined power percent of a corresponding one of the plurality of components falls into; and
determining the power state of each of the plurality of components associated with the determined power percentage range of the corresponding one of the plurality of components.

10. The monitoring frequency adjustment method as described in claim 7, wherein the method further comprises:
setting a plurality of power states for each of the plurality of components and setting a monitoring frequency for each of the plurality of power states of each of the plurality of components; and
storing the power states of each of the plurality of components and the monitoring frequencies associated with each of the plurality of components at different power states.

11. The monitoring frequency adjustment method as described in claim 10, wherein each of the plurality of power states of each of the plurality of components is represented via a corresponding one of the power percentage ranges.

12. The monitoring frequency adjustment method as described in claim 11, wherein the method further comprises:
storing the power percentage ranges of the components associated with the power states of the components.

13. A non-transitory storage medium storing a set of instructions, the set of instructions capable of being executed by a processor of a server, causing the server to perform a monitoring frequency adjustment method, wherein the method comprises:
monitoring a power state of each of the plurality of components at preset intervals;
determining a monitoring frequency of each of the plurality of components associated with the determined power state of a corresponding one of the plurality of components; and
adjusting the preset intervals for monitoring each of the plurality of components to the determined monitoring frequency of the corresponding one of the plurality of components.

14. The non-transitory storage medium as described in claim 13, wherein the method further comprises:
determining a power percentage of each of the plurality of components at preset intervals to monitor the power state of each of the plurality of components at preset intervals.

15. The non-transitory storage medium as described in claim 14, wherein the method further comprises:
obtaining an actual power consumption of each of the plurality of components from a corresponding one of the plurality of sensor via a system interface of an IPMI architecture;
determining a power percent of each of the plurality of components according to the obtained actual power consumption of each of the plurality of components and a stored rated power consumption of each of the plurality of components;
determining which power percent range of each of the plurality of components that the determined power percent of a corresponding one of the plurality of components falls into; and
determining the power state of each of the plurality of components associated with the determined power percentage range of the corresponding one of the plurality of components.

16. The non-transitory storage medium as described in claim 13, wherein the method further comprises:
setting a plurality of power states for each of the plurality of components and setting a monitoring frequency for each of the plurality of power states of each of the plurality of components; and
storing the power states of each of the plurality of components and the monitoring frequencies associated with each of the plurality of components at different power states.

17. The non-transitory storage medium as described in claim 16, wherein each of the plurality of power states of each of the plurality of components is represented via a corresponding one of the power percentage ranges.

18. The non-transitory storage medium as described in claim 17, wherein the method further comprises:
storing the power percentage ranges of the components associated with the power states of the components.
